(19) United States
(12) Patent Application Publication
(10) Pub. No.: US 2015/0006428 A1
(43) Pub. Date: Jan. 1, 2015

(54) FREIGHT SHIPMENT BOOKING SYSTEM

(71) Applicant: 10-4 Systems, Inc., Boulder, CO (US)

(72) Inventors: Toby Miller, Waterville, OH (US); John Basso, Boulder, CO (US); Travis L. Rhyan, Boulder, CO (US)

(21) Appl. No.: 14/318,311

(22) Filed: Jun. 27, 2014

Related U.S. Application Data
(60) Provisional application No. 61/840,892, filed on Jun. 28, 2013.
(60) Provisional application No. 61/841,043, filed on Jun. 28, 2013.
(60) Provisional application No. 61/841,055, filed on Jun. 28, 2013.
(60) Provisional application No. 61/841,062, filed on Jun. 28, 2013.
(60) Provisional application No. 61/884,270, filed on Sep. 30, 2013.

(51) Int. Cl. G06Q 10/08

(52) U.S. Cl. CPC G06Q 10/0835
USPC 705/336

(57) ABSTRACT

A method of establishing a freight shipment comprising interfacing with one or more transportation management systems and load boards. Data comprising one or more available freight loads and freight capacity is transmitted from the one or more transportation management systems in substantially real time. The one or more available freight loads and freight capacity are searched and one or more of the one or more available freight loads are matched with one or more of the one or more available freight capacity. The method continues with negotiating one or more details of a contract between the one or more of the available freight loads and one or more of the freight capacity, confirming the details between the one or more of the available freight loads and one or more of the freight capacity, collecting invoicing information, and inserting electronic receivables in one of the transportation management systems and load boards the one or more details of the contract.

### PRIORITY

This application claims priority to U.S. Provisional Application Nos. 61/840,892, filed Jun. 28, 2013 and entitled SYSTEM FOR ONLINE FREIGHT NEGOTIATION; 61/841,043, filed Jun. 28, 2013 and entitled REAL TIME FREIGHT NEGOTIATION USING DISPARATE SYSTEMS; 61/841,055 filed Jun. 28, 2013 and entitled SYSTEM FOR MATCHING FREIGHT REQUESTS TO SHIPPING CAPACITY, 61/841,062, filed Jun. 28, 2013 and entitled SYSTEM FOR EXCHANGING TARIFF AND TRADING COMMODITY INFORMATION, and 61/884,270, filed Sep. 30, 2013 and entitled SYSTEM FOR MATCHING FREIGHT REQUESTS TO SHIPPING CAPACITY USING ELECTRONIC ONBOARD RECORDING DATA, each of which are incorporated by reference.

### FIELD OF THE INVENTION

Aspects of the present invention relate to freight shipment. In particular, but not by way of limitation, the present invention relates to facilitating business transactions between multiple parties in the freight industry.

### BACKGROUND OF THE INVENTION

There are estimates of over 15 million trucks in the US, and from 500,000 to over 1 million trucking companies operating in the US, with 90% of the companies having less than 20 trucks (“independents” or an “independent carrier”). Currently, shippers (e.g. manufacturers), freight shipment brokers (also referred to herein as brokers) and freight carriers (also referred to herein as carriers) conduct business transactions in a direct business to business model. For example, a shipper that uses an independent carrier first locates a carrier from thousands of options by sorting through the various services offered by each carrier, and applying each carrier's stated rules to determine which carrier(s) offer a service with which to deliver a particular load according to the shipper's requirements. Additionally, the shipper must contact the carrier to further clarify unstated rules. If the shipper determines that more than one carrier offers a service to deliver a particular shipment according to the shipper's requirements, then the particular shipper might additionally be concerned with selecting a carrier and service that provide shipping services at the optimal price.

Although applications currently used in the industry such as, but not limited to, transportation management systems (TMS systems) and Load Boards have provided some automated services to the shipping industry, there is a greater need to optimize matching and negotiating services between shippers, brokers, and carriers, to create more efficiency in the market as such current applications limit the types of freight shipment services to those that are only based on cost, distance, and/or transit time, and do not consider other metrics when presenting comparisons of shipment service options.

### SUMMARY OF THE INVENTION

Accordingly there is an unaddressed need in the industry to address the aforementioned deficiencies and inadequacies. One embodiment of the invention comprises a non-transitory, tangible computer-readable storage medium, encoded with a processor readable instructions configured to perform a method of completing a freight shipment contract. Such a method may comprise interfacing with one or more transportation management systems and load boards and transmitting data comprising one or more available freight loads and available freight capacity from the one or more transportation management systems and load boards in substantially real time. The method may further comprise reviewing the one or more available freight loads and freight capacity, matching one or more of the one or more available freight loads with one or more of the one or more available freight capacity, and negotiating one or more details of a contract between a first entity associated with the one or more of the available freight loads and a second entity associated with one or more of the freight capacity. Finally, the method may comprise confirming the details between the first entity and the second entity, collecting invoicing information and providing electronic receivables.

Another embodiment of the invention comprises a method of completing a freight shipment contract comprising interfacing with one or more transportation management systems and load boards, transmitting data comprising one or more available freight loads and available freight capacity from the one or more transportation management systems and load boards in substantially real time, and reviewing the one or more available freight loads and freight capacity. The method further comprises matching one or more of the one or more available freight loads with one or more of the one or more available freight capacity, negotiating one or more details of a contract between a first entity associated with the one or more of the available freight loads and a second entity associated with one or more of the freight capacity, confirming the details between the first entity and the second entity, collecting invoicing information and providing electronic receivables.

Yet another embodiment of the invention comprises a freight shipment booking system. The freight shipment booking system may be adapted to interface with one or more transportation management systems and load boards. The system may be further adapted to transmit data comprising one or more available freight loads and available freight capacity from the one or more transportation management systems and load boards in substantially real time. Furthermore, the system may review the one or more available freight loads and freight capacity, match one or more of the one or more available freight loads with one or more of the one or more available freight capacity, negotiate one or more details of a contract between a first entity associated with the one or more of the available freight loads and a second entity associated with one or more of the freight capacity, confirm the details between the first entity and second entity, collect invoicing information, provide electronic receivables, enable at least one of a driver and the freight carrier to opt into a track and trace service, and have a location used for the matching the available freight loads with the available freight capacity.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates a freight shipment booking system according to one embodiment of the invention;

FIG. 2 illustrates a flowchart depicting a method of a matching and negotiating process according to one embodiment of the invention;

FIG. 3 illustrates a flowchart depicting a method of matching loads with capacity and negotiating a freight shipment cost according to one embodiment of the invention;

FIG. 4 illustrates a flowchart depicting a method of tendering according to one embodiment of the invention;

FIG. 5 illustrates a track and trace system according to one embodiment of the invention;

FIG. 6 illustrates a diagrammatic representation of one embodiment of a machine according to one embodiment of the invention;

FIG. 7 illustrates a flowchart depicting a method of matching a load with an available capacity according to one embodiment of the invention;

FIG. 8 illustrates a flowchart depicting a method of matching loads and capacity according to one embodiment of the invention;

FIG. 9 illustrates a freight shipment booking system according to one embodiment of the invention;

FIG. 10 illustrates a system comprising an EOBR service provider extracting data from an EOBR according to one embodiment of the invention; and

FIG. 11 illustrates a flowchart depicting a method of matching loads and capacity according to one embodiment of the invention.

### DETAILED DESCRIPTION

One embodiment of the invention comprises a system and method to provide online offering, matching, and negotiating of freight business between two or more parties such as, but not limited to, shippers, brokers and carriers (i.e., “parties”). One such system and method match a shipper and carrier for the purpose of negotiating and confirming a freight transaction. For example, the system and method may interface to and upload/download data from various Transportation Management System (TMS) systems and freight load boards. In one embodiment, a graphical user interface (GUI) may be used by a freight owner or any other party, with the GUI having a capability to post or accept a shipping need with a desired pick up date, delivery date, carrier type need, city of origin and city of destination. In one embodiment, a freight owner may comprise the first entity that takes responsibility for the freight and may comprise a shipper or a broker. A carrier may comprise a second entity. Confirming a freight transaction may comprise collecting invoicing information and providing electronic receivables. Electronic receivables may comprise one or more documents exchanged between one or more parties to a freight transaction. These documents may be exchanged once a deal has been completed. Such an exchange process may comprise determining whether a preexisting agreement has been established between two or more of the parties, e.g. a Master Service Agreement. In one embodiment, a master service agreement may be set up between one or more shippers and brokers. After determining whether a preexisting agreement has been established, a rate confirmation document (or electronic file) which may define one or more terms of a specific freight transaction may be exchanged between one or more parties. As the shipment works its way to the final customer Invoicing, POD (proof of delivery-signed, etc.), bill of lading and other documents are exchanged. One POD may comprise a picture of a signed delivery receipt, which may be sent through the system 100 to the shipper or any other user, which may trigger an invoicing process.

In one embodiment, a shipment may be matched with qualified carriers based on the information entered by the shipper, posted by the carrier, and/or uploaded from the TMS systems and load boards. A carrier may respond to a shipper posting with a bid for the service. A shipper may be allowed to view each bid and to accept, decline, or counter the offer. This bidding process may also be described herein as a negotiation process and may continue in an anonymous fashion until an offer, also referred to herein as a bid, or a counteroffer, is accepted. Upon accepting an offer or counteroffer, the system and method may prepare an agreement, obtain a rate confirmation, and execute a contract between the parties by receiving electronic signatures and delivering confirmation to each party. The anonymity between the parties may be kept until an agreement is reached or until a specified process step is reached (e.g. agreement on price, destination city, etc.). The system and method may enable accurate pricing and facilitate the payment from the shipper to a carrier per the terms and conditions of the agreement and the service.

In one embodiment, the details of the agreement may be automatically transmitted to a carrier's TMS system to create a load in the TMS system without manually inputting the information. Load details may then be received from the carrier's TMS system or other device and a freight invoice may be electronically sent to the shipper or broker. The freight invoice information may be received from the carrier and through an interface with a shipper or broker TMS system; the invoice may be registered as paid in the systems once it is paid. Furthermore, remittance details may be collected from the shipper and the details may be sent electronically to the carrier.

The system and method described herein may match a shipper's freight requirements with a carrier's shipping capacity. In certain embodiments, a shipper posts a shipping need on the system and is matched with one or more carriers that meet the posted shipping need requirements. Freight and capacity data may be automatically extracted from the systems of a shipper, broker and/or carrier. This data may be organized into a common system for use by various shippers, brokers, and/or carriers, with one or more of the shippers, brokers, and carriers having proprietary systems. One common system may reside on a web server. The shippers, brokers, and carriers may be referred to herein as users of the system. Such users may set preferences for various data attributes and the system may implement one or more factors to determine a best match between the shippers/brokers/carriers, and present the matches to the users.

For example, a user may manually enter data into one or more forms which may be used to provide the data attributes. Such information may also be entered automatically. These forms may be electronic in nature and may be sent between users and system devices, which may be adapted to access the forms, obtain the data attributes from the forms, and create a match between a shipper/broker/carrier. One form may be generic across all users and/or another form may be specific to each user. One form, such as the specific form, may enable a user to determine which information is prevented from being publicly displayed and/or otherwise being accessed by a user and/or system device (i.e., the “marketplace”). One form, such as the specific form, may be created by extracting user-specified or otherwise user identified information from a user's TMS (which may be different for each user). The extracted information may be displayed in the portal (the web server or other system device, described below). Users may also select what category of data may be shared with or by the marketplace. For example, a carrier may classify any information related to a truck fleet as public information. Or, the truck fleet information may be only accessed by a specific shipper. Or, one or more portions of the truck fleet information may be public (e.g., truck type) while one or portions of the truck feet information (e.g., location) may be accessed by a specific shipper or shippers/brokers.

Data attributes may comprise information related to one or more of, rate per mile (minimum, maximum, average, median, or any other metric known in the art), revenue (total, over a specified period of time, or any other metric known in the art), distance (total, minimum, maximum, deadhead miles, between specific locations such as, but not limited to a load location to a next location, or over a period of time such as per day, etc., track away from a specified home base, or any other metric known in the art), number of stops (total, intermediate, minimum, maximum, or any other metric known in the art), Location of home base or any other specified location, exclude origination or destination location (country, state/provinces, postal codes, or any other metric known in the art), temperature (range, maximum, minimum, enable load, or any other metric known in the art), hazardous materials (“hazmat”), and weight or other size limitations.

The one or more factors implemented by the system may comprise the following: distance between pickup and/or drop-off (relative or otherwise), truck location (previous, current, or future), distance between two specified points (e.g. current location and future drop-off), date, time, and equipment type.

Another embodiment of the system may provide a “track and trace” service where, for example, a driver for a carrier may use a mobile device to register and opt into the track and trace service. Brokers and shippers may then access the information in the track and trace service. This location of a carrier may be used in the process matching shipments with capacity. In one embodiment, a carrier may have an option to use a mobile computing application to look for a shipment near the carrier or to be matched with a shipment searching for capacity and a carrier. The track and trace service may be initiated through one or more of the following: (a) downloading and operating a mobile application on a mobile communications device operating a GPS position system or other device positioning system, (b) a TMS system, (c) a mobile communications provider, (d) a third-party trace-and-trace service provider, or (d) doing nothing.

One user of a carrier track and trace service may select data obfuscation so that a GPS or other mobile phone tracking information of the carrier is provided as a general location for presentation purposes. The term “track and trace,” as used herein may refer to a process of determining past, current, and potentially future locations (and other information) of an item being shipped or a carrier. Such locations may be determined by determining the position of vehicles and/or a containers comprising the item and storing the item in a real-time database. Locations may also be determined by obtaining an arrival and/or departure time of an object and recording information relating to identifying the object, the location where the object was observed, the time, and a status.

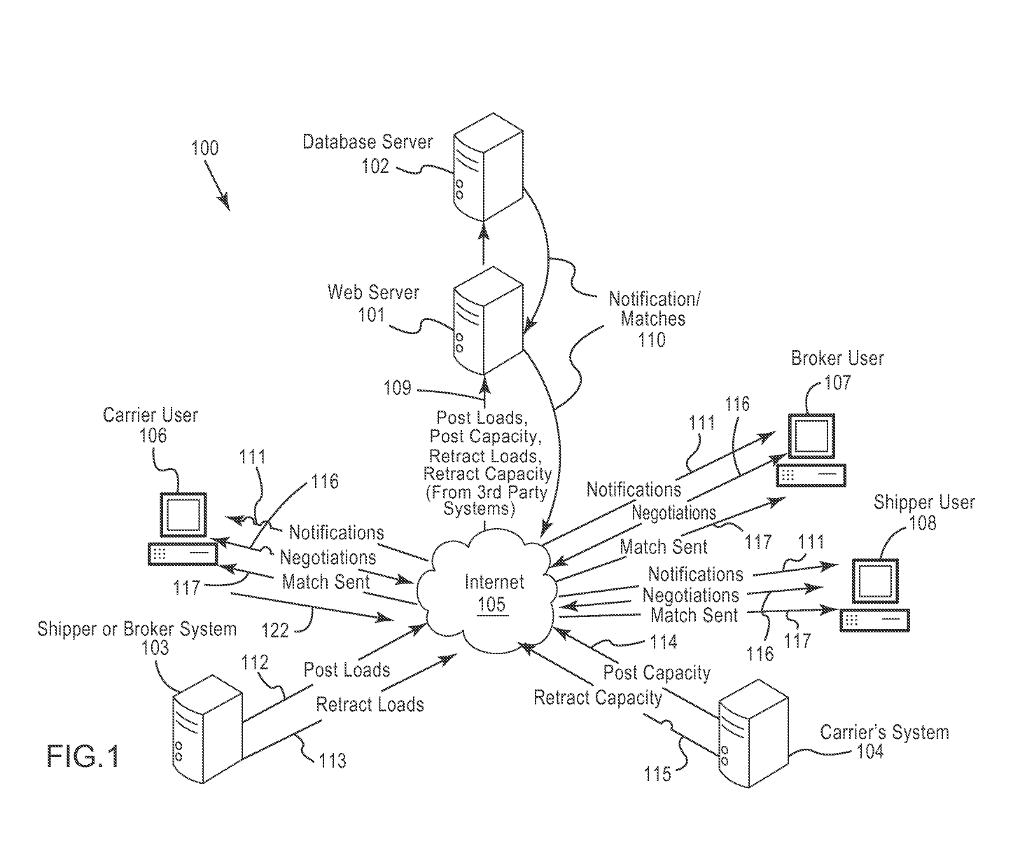

Turning now to FIG. 1, seen is an exemplary embodiment of a freight matching system 100. One freight matching system is adapted to automatically match cargo load information 112, which may be provided from a shipper/broker 103, with load capacity information 114, which may be provided from a carrier 104. In general, the term “carrier” is used herein to refer to a trucking company that provides freight shipment services while the term “shipper” is used herein to refer to a company that engages a carrier to transport a load of freight. The term “broker” is used herein to refer to an entity that may represent and act on behalf of a carrier or a shipper. The phrase “Third Party Logistics,” “3PL or “TPL” is often used in the freight industry in the place of “broker.”

The freight matching system 100 may also be adapted for use with recurring shipments. For example, any freight matching system 100 features described herein may be used to establish one or more additional shipments. These recurring shipments may be set by a user to automatically be established in the system at a defined time prior to, or at the time the shipment occurs. Varying recurring controls may be used for such a feature such as, but not limited to, time-based controls (daily/weekly/monthly recurring shipments), load-based controls (one type, weight, etc. of shipment for every other shipment, for example), etc. A third-party logistics provider may also provide part, or all, of a company's supply chain management. For example, third party logistics providers may provide warehousing and transportation services that can be scaled and customized to a customer's needs based on market conditions—the demand for particular goods and logistics entailed with delivering those goods.

A broker may purchase and sell shipping capacity. Such a freight broker may comprise an individual or company that serves as a liaison between a shipper and carrier. Though a freight broker plays an important role in the movement of cargo, the broker doesn't typically provide the services of a shipper or a carrier. Instead, a freight broker may work to determine the needs of a shipper and connect the shipper with a carrier willing to transport the items at an acceptable price.

One system 100 may comprise one or more computing devices such as, but not limited to, a web server 101 in communication with a database server 102. The web server 101 may be in further communication with a network such as, but not limited to, the Internet 105. This network may enable the shipper/broker 103, carrier 104 and various users 106, 107, 108 to access resources residing within the system 100. The terms user 106, 107, and 108 may also be referred to herein as carrier users 106 carriers 106, broker users 107, brokers 107, shipper users 108 and shippers. In one embodiment, the web server 101 may comprise data and content organized on one or more web pages associated with one or more websites that are accessible and viewable by the carrier users 106, broker users 107, and shipper users 108 using a web browser program executing on a computing device such as, but not limited to, a personal computer or laptop. The carrier users 106, broker users 107, and shipper users 108 may also submit information and data to the web server 101 and the database server 102 using the web browser and other programs.

One database server 102 may also be coupled to the web server 101 via a computer network (local area network, metropolitan area network, wide area network, virtual private network, intranet, Internet 105, etc.). The database server 102 may store data and perform query and lookup functions. In particular, the database server 102 may be operable to store profile data and load data relating to the carriers 106, brokers 107, and shippers 108, including but not limited to company name, address, contact person, email address, landline telephone number, mobile telephone number and service provider, load preferences, trailer type preferences, pickup and delivery location preferences, and other information.

It should be understood that the system 100 may employ a single powerful server to perform the functions of the web server 101, database server 102, and/or any other portion of the system 100. Alternatively, multiple computers may be employed to provide the functionality provided by the web server 101, database server 102 and/or any other portion of the system 100. Furthermore, the web server 101, database server 102, and/or any other portion of the system 100 may reside behind a firewall or any other form of security measure. Data backup servers may be used as well as other data storage services such as cloud servers.

One system 100 may automatically queries the shipper/broker 103 to post a load 112 that will be open to bidding. For example, if a shipper/broker uses a TMS (onsite or otherwise), the TMS may be queried periodically to determine when loads or trucks are available. Such query may be enabled through a locally-stored software module or may be performed through a cloud-based system. In other embodiments, a company may employ a Software As a Service (SaaS) system, in which case one or more web or cloud-based services may enable the SaaS provider to access the system 100 and notify the system 10 when a load and/or a truck is available. Conversely, the SaaS provider may be accessed by the system 100 as well.

The term shipper/broker may also be referred herein as a shipper or broker system or a shipper or broker's Transportation Management System (TMS). In one embodiment, the TMS may comprise a software and/or hardware application designed to manage and optimize inbound and/or outbound transportation operations. The TMS may integrate and/or otherwise communicate with an enterprise resource planning (ERP) system, Order Management System (OMS), or Warehouse Management System (WMS). The ERP (or OMS/WMS) application passes inbound and/or outbound orders to the TMS which may then determine the optimized transportation cost and routing. For example, the TMS may evaluate the pool of orders; consolidate them into potential shipments, and determine the proper mode/lane/carrier/route/stop assignments to minimize transportation expenses while maintaining customer service level constraints. In some cases the TMS system performs the function of an ERP system specifically for shippers. The TMS system may function to provide analysis to assist a company in selecting a carrier and mode of transportation.

Transportation management systems manage four key processes of transportation management: (1) Planning and decision making—TMS will define the most efficient transport schemes according to given parameters, which have a lower or higher importance according to the user policy: transport cost, shorter lead-time, fewer stops possible to ensure quality, flows regrouping coefficient, etc.; (2) Transportation Execution—TMS will allow for the execution of the transportation plan such as carrier rate acceptance, carrier dispatching, Electronic data interchange (EDI), etc.; (3) Transport follow-up—the TMS may enable administrative operation regarding transportation. For example, the TMS may enable the traceability of items by event (shipping from A, arrival at B, customs clearance, etc.), editing of reception, custom clearance, provide invoicing and booking documents, and send transport alerts (delay, accident, non-forecast stops . . . ); and (4) Measurement—the TMS may comprise a transport logistics key performance indicator (KPI). These events may occur while a shipment is moving from its origin to its destination. Typical events may include: arrived at destination, unloading, and transferring of goods to another truck, etc. Whatever the event, the event may be tracked and reported. KPI is an industry wide term used to describe the ability to define what is important to the business and ability to track it and report on it. Beyond the KPI indicator, the TMS may also include utilization rate, trucks under repair, driver hours, number of drivers that meet different certifications or any other metric known in the art may be the KPI. Electronic data interchange (EDI) may comprise a method for transferring data between different computer systems or computer networks, potentially for e-commerce purposes, such as, but not limited to, sending orders to warehouses or tracking their order. It may comprise more than mere e-mail, for example, organizations may replace bills of lading and even checks with appropriate EDI messages and may comprises a family of standards.

Further, the system 100 may automatically query the carrier system 104, which may be referred to herein as a carrier freight system, to post available capacity 114. The available capacity data may be accessed on the carrier 104 by one or more of a direct database access, file access, socket direct protocol, or web services. Direct database access may comprise the ability to extract or modify data from a database. Socket direct protocol may comprise a networking protocol developed to support high-speed data streaming with low latency. File access may comprise the capability to access, transfer, or extract data from a file system automatically from a remote software program using file system API's (Application Programmer's Interface). Web Services may comprise a collection of protocols and standards used for exchanging data between applications. Software applications written in various programming languages and running on various platforms may use web services to exchange data over computer networks like the Internet.

The capacity and load data may be accessed and extracted via the internet 105 and uploaded 109 to the web server 101. The database server 102 may perform one or more matching functions 110 such that shippers 108 are then presented with the best matched carriers 106 and brokers 107. Alternately, the match process may be based on information input manually by either party via spreadsheet or compatible file. Shippers 108 may then conduct negotiations 116 with brokers and carriers. Negotiations 116 may occur through a pop-up window or other interface in the shipper 104 and carrier 106 device. Negotiations 116 may comprise a real-time exchange of text, audio, video, graphics, and any other media. The system 100 further provides notifications 111 to all parties during the matching and negotiation processes. Notification is provided via an interactive pop-up notification alert window that displays information relevant to the specific status with an icon to differentiate what type of status. The notification alert window also allows the user to take actions to proceed to the next step in the match, negotiation, offer, or confirmation process. Finally, in the case where a shipper 108 may cancel or repurpose a load, the system 100 will issue a load retraction 113. Also, in the case where a carrier or broker may fill or otherwise cancel capacity, the system 100 will issue a capacity retraction 115. A spreadsheet file or a compatible file may comprise a file from an interactive computer application program for organization and analysis of data in tabular form. Spreadsheets may be developed as computerized simulations of paper accounting worksheets and may operate on data represented as cells of an array, organized in rows and columns. Files may be saved either in the application program format (e.g. Microsoft Excel) or a compatible file format such as “comma separated value” (CSV) or “tab delimited text” (TXT).

A graphical user interface may be made available to all users of the system 100. Such a graphical user interface may provide the capability to view matches between available capacity and loads, negotiate loads and capacity, send and receive notifications, and sign contracts. Users may also post or search for a shipping capacity. A carrier may make a bid or offer to a shipper. A shipper may input information of one or more of the following: city of origin, city of destination, desired pick up date, desired delivery date, flexibility of pick up date, flexibility of delivery date, type of carrier equipment, commodity, and accessorial information. The shipper may also view bids by one or more carriers and via the graphical user interface, accept, decline, or counter the bid. As part of this process, the rate, commodity, freight data, and terms of the transaction may be exchanged. Accessorial information or accessorial charges may comprise charges made for performing services beyond normal pickup and delivery, such as inside delivery or storage

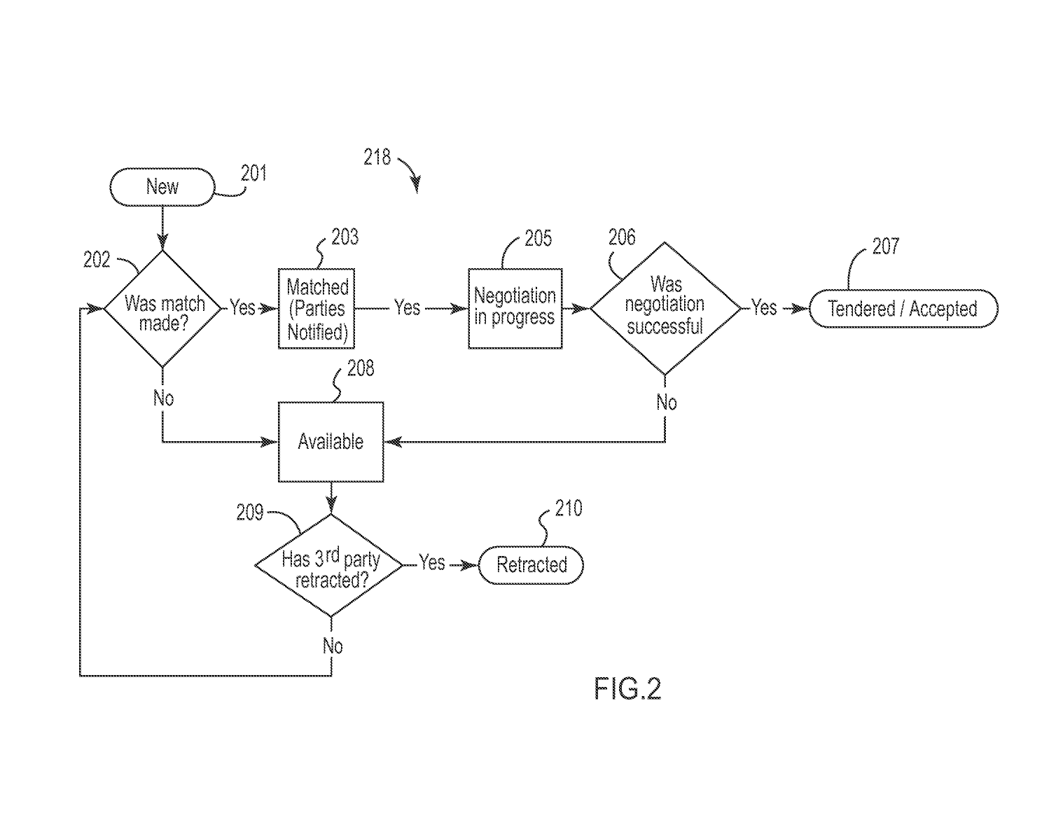

Turning now to FIG. 2, with reference to FIG. 1, where available, seen is an exemplary method 218 of a matching and negotiating process which may be used by the system 100 seen in FIG. 1. In the FIG. 2 flowchart, a new load 201 is posted, for example by a shipper 108 or a broker 107 at the shipper/broker system 103. The new load 210 is then sent to the web server 101 for matching 110 with available shipping capacity that's been posted or automatically queried by the carrier 106 and/or carrier system 104. At 202, it is determined if a match with available capacity has been made. If so, the match is identified and the parties are notified at 203—for example, through for example, the pop-up notification alert window. If it is determined that a match with available capacity was not made at 202, then the load is made available 208 again for matching. At 204, it is determined whether the negotiation was initiated within a specified first time limit 204. As matches are determined by the system 100 as data is received from the users, each party involved in a match is notified (pop-up window, email, text, etc.). One user may be involved in multiple negotiations for a single load or a single truck or the combination of both. The first person to “accept” the offer is the winner. Anyone who receives a notification of a match may negotiate until somebody accepts the offer. Such a process comprises (a) a match occurring, (b) a price being offered, and (c) an offer being accepted. It is also possible that only one negotiation may occur per load or truck or combination at a time. When new loads or trucks are entered the system, new matches may be created and added to each party's current list of matches. If the negotiation was initiated within a specified time limit, then the negotiation is continued at 205. At 206, if the negotiation of 205 is not successful within a second specified time limit, the load is again made available 208 for matching. If the negotiation is successful 206 within a specified time limit, then the match is ready to be tendered/accepted 207.

Further in the case where the load is again made available 208 for matching, if the load has been retracted 209 from the system 100, such as, but not limited to the refraction 113 seen in FIG. 1, then the load is retracted 210 from the system, and no new matches will be found for the load. If the load has not been retracted 209, then a new match 202 is found for the load.

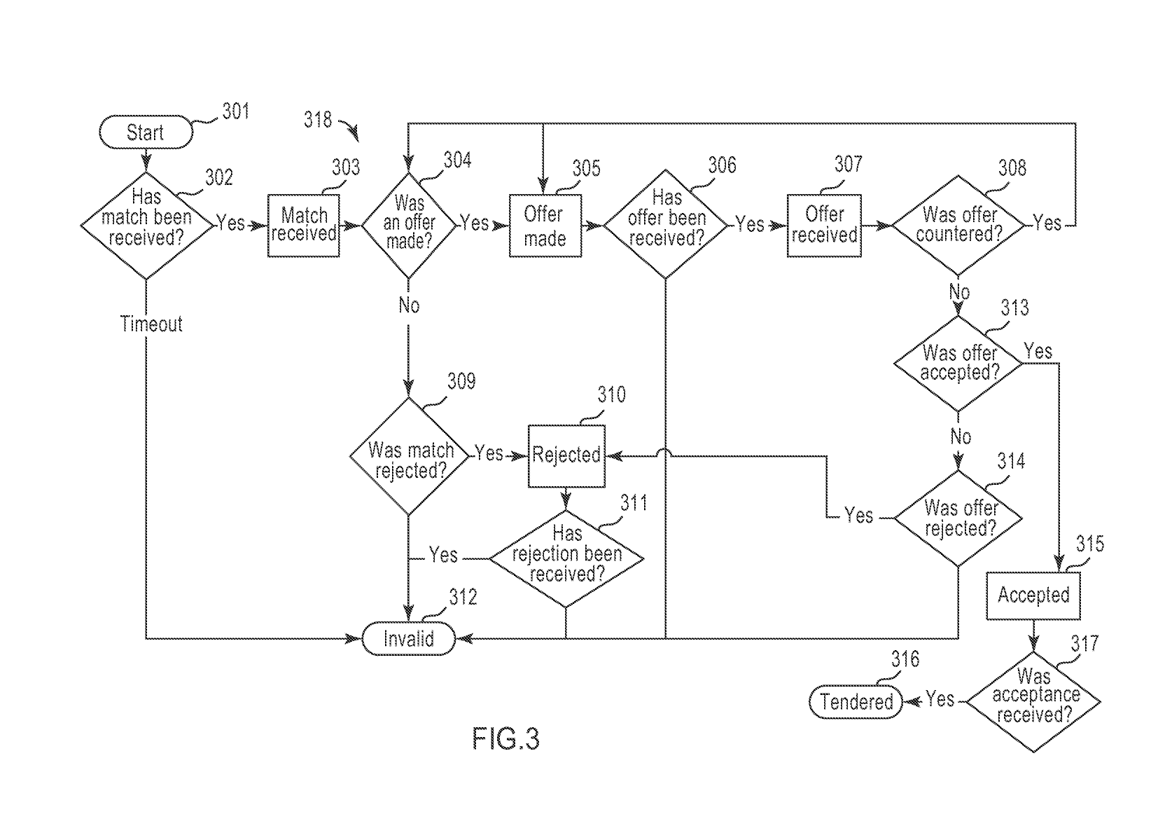

Turning now to FIG. 3, seen are further details of an exemplary method 318 of matching loads with capacity and the bidding process between shippers 108, carriers 106, and brokers 107. The method 318 starts at 301 and at 302 it is determined if a match has been made between a received load and capacity such as, but not limited to the load 112 and capacity 114 from FIG. 1. If a match has been received at 303, the method 318 moves to 304 and it is determined whether a carrier has made an offer. For example, a carrier 106 may provide a price bid to ship the load 112. However, if no offer is made by a carrier 106 to ship the load 112, then it is determined at 309 whether the match was rejected if so, the match is labeled as rejected at 310. When an offer is made 305 by a carrier 106, at 306 it is determined if the offer has been received by the system 100. If, at seen at 307, the offer has been received at the system 100, the method 318 moves to 308 where it is determined if a counteroffer has been submitted by the shipper. If yes, then the method returns to step 305 and/or 304 of determining whether an offer was made. The method 318 will continue this loop until a counteroffer was not submitted at 308, at which point the method 318 moves to determining whether the offer was accepted at 313. If the offer is rejected, at 314, the offer is labeled as rejected at 310. If the offer is accepted the offer is labeled as accepted at 315 and at 317 it is determined if the acceptance was received by determining if the user chose to accept the offer instead of reject or counter the offer.

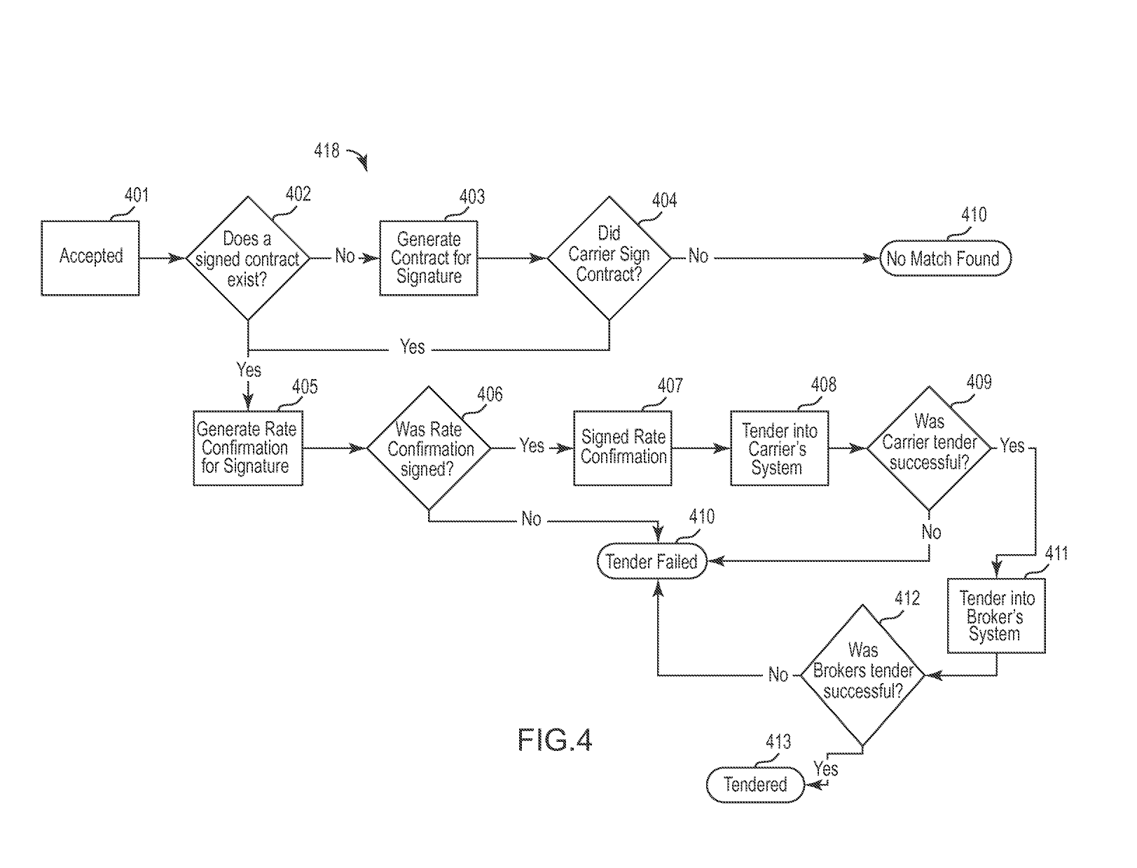

Turning now to FIG. 4, seen is a method 418 of tendering. In one embodiment, tendering may refer to the process after a load/capacity rate negotiation is accepted by the shipper 108 and/or carrier 106. It is contemplated that throughout the application, whenever the term shipper 108 is used, such a term may also apply to the term broker, and vice versa. Such a process may comprise preparing legal documents, creating a load in the carrier system 104, electronically sending a freight invoice to the shipper/broker system 103, register the invoice for payment within the shipper/broker system 103, collect remittance details from the shipper 108 and/or electronically send details and receipt to the carrier 106.

Tendering may comprise an acknowledgement in a freight management system that a portion of the freight shipment has been completed. For example, a freight management system may be informed that a deal was entered into outside of the system. Through a tendering process, two or more freight management systems may be kept in-sync. This may be important because there may be custom workflows set up in each freight management system that determine what steps need to be taken in what order once a deal has been entered into and therefore a truck/load has been booked. When a tendering process occurs, a freight management system may be updated with all the data it needs so business flow and operations can continue as if the truck/load was booked within their system instead of outside the system.

The exemplary tendering method 418 seen in FIG. 4 commences when a negotiation is accepted 401. At 402 it is determined whether a signed contract already exists. If so, due to, for example, prior business being conducted between the parties (e.g. shipper 108 and carrier 106), then at 405 a rate confirmation is generated for signature by the parties. If the signed contract does not exist, at 403 a contract covering the details of the load shipment is generated for signature. At 404 it is determined whether a carrier 106 has signed the contract. If so, then the rate and confirmation is generated at 405. Should the carrier not sign the contract, then the tender is considered no match found at 410. At 406 it is determined whether the rate confirmation was signed by the carrier 106. Should the carrier 106 not sign the rate confirmation, the tender is designated as no match found at 410. When the rate confirmation is signed by the carrier 106 at 407, the tender is posted and the load is created within the carrier's system 104 at 408. At 409, it is determined whether the carrier's tender was successful. When this tender step is successful, at 411 the tender, or freight invoice information, is registered into the shipper/broker system 103. Upon success of tender to the shipper/broker system 103, it is determined whether the tender was successful at 412. If so, the load is tendered at 413. If, at 409 the carrier's tender is not successful and/or at 412 the tender was not successful, the tender is designated as no match found at 410.

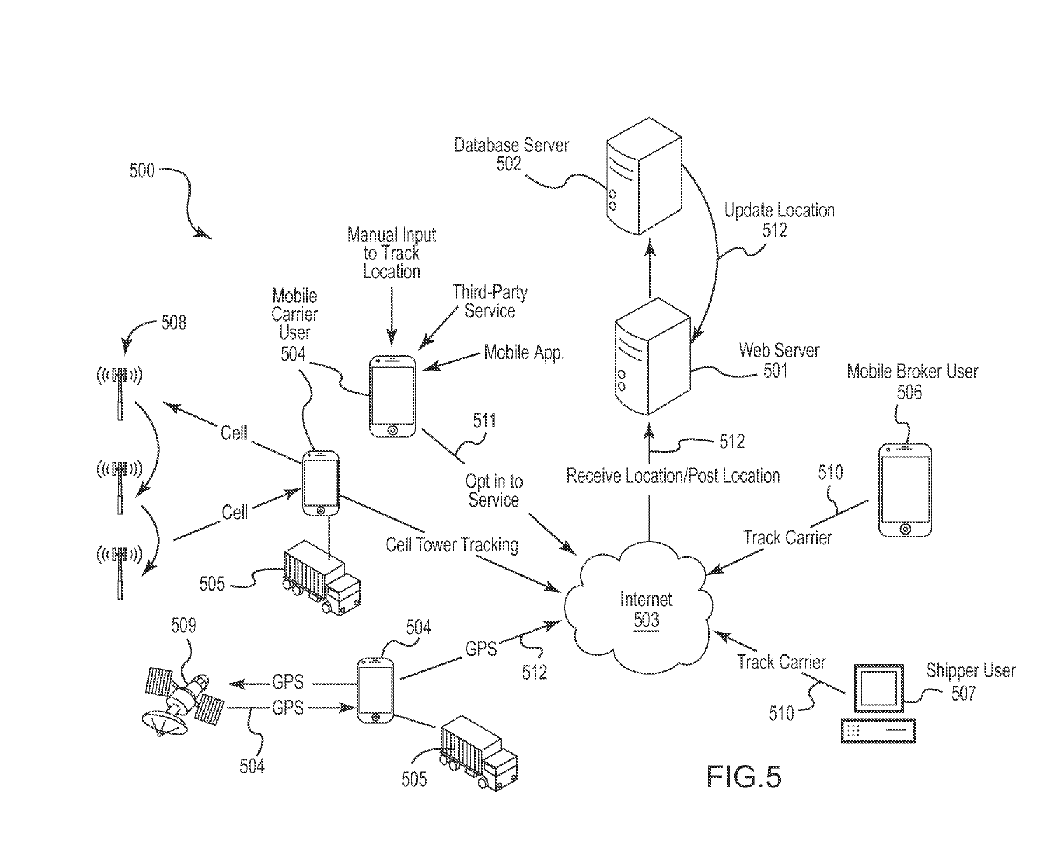

Turning now to FIG. 5, seen is an embodiment of a track and trace system 500. In one embodiment, a mobile carrier user 504 comprising a mobile phone device may opt in 511 to a track and trace service provided by, for example, a carrier system 104 seen in FIG. 1. The track and trace service may identify a location of the mobile phone device as the location of the mobile carrier user 504. Such a location may also be identified as a location of a truck 505 or other transportation medium transporting the goods. The location may be determined by a mobile phone location or a location obtained from a cellular tower 508—for example via triangulation, or a location obtained via a satellite Global Positioning System (GPS) 509 or other satellite location system. Upon obtaining location information for a carrier, the location information is sent 512 from the mobile 504 to the web server 501. Referring to FIG. 1, a broker 106 and shipper 107 may have the capability to track 510 the carrier 504, thereby tracking the load. In one such embodiment, a user or a carrier, etc., of a mobile application may have an option to select data obfuscation so that the location information of the carrier 504 is provided as a general location rather than a specific location for security or privacy purposes.

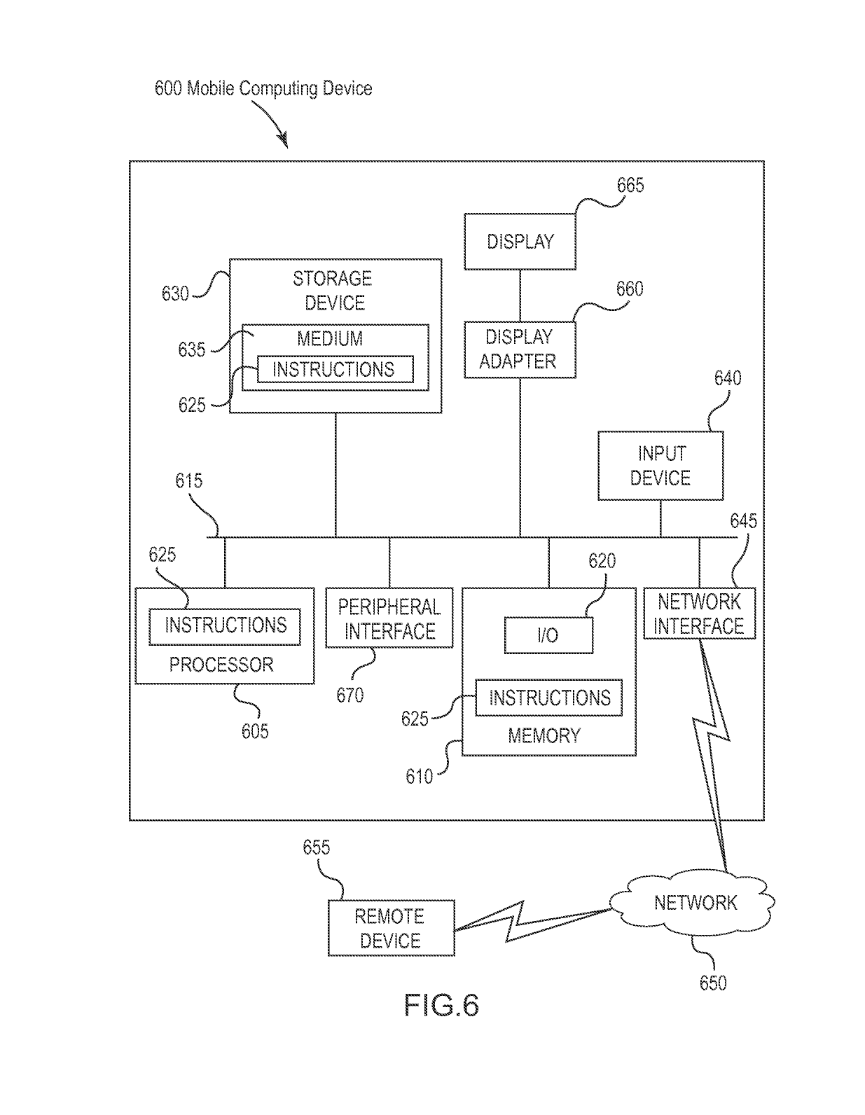

FIG. 6 shows a diagrammatic representation of one embodiment of a machine in the exemplary form of a computer system 600 within which a set of instructions for causing a device to perform any one or more of the aspects and/or methodologies of the present disclosure to be executed.

In FIG. 6B, Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Memory 610 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof.

Computer system 600 may also include a storage device 630. Examples of a storage device (e.g., storage device 630) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 may be removably interfaced with computer system 600 (e.g., via an external port connector (not shown)). Particularly, storage device 630 and an associated machine-readable medium 635 may provide nonvolatile and/or volatile storage of machine-readable instructions, data structures, program modules, and/or other data for computer system 600. In one example, software 625 may reside, completely or partially, within machine-readable medium 635. In another example, software 625 may reside, completely or partially, within processor 605. Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof.

A user may also input commands and/or other information to computer system 600 via storage device 630 (e.g., a removable disk drive, a flash drive, etc.) and/or a network interface device 645. A network interface device, such as network interface device 645 may be utilized for connecting computer system 600 to one or more of a variety of networks, such as network 650, and one or more remote devices 655 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 650, may employ a wired and/or a wireless mode of communication. In general, any network topology may be used. Information (e.g., data, software 625, etc.) may be communicated to and/or from computer system 600 via network interface device 645.

Computer system 600 may further include a video display adapter 660 for communicating a displayable image to a display device, such as display device 665. A display device may be utilized to display the various screens discussed above with reference to the figures. Examples of a display device include, but are not limited to, a liquid crystal display (LCD), a cathode ray tube (CRT), a plasma display, and any combinations thereof. In addition to a display device, a computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof. In one example an audio device may provide audio related to data of computer system 600.

A digitizer (not shown) and an accompanying stylus, if needed, may be included in order to digitally capture freehand input. A pen digitizer may be separately configured or coextensive with a display area of display device 665. Accordingly, a digitizer may be integrated with display device 665, or may exist as a separate device overlaying or otherwise appended to display device 665.

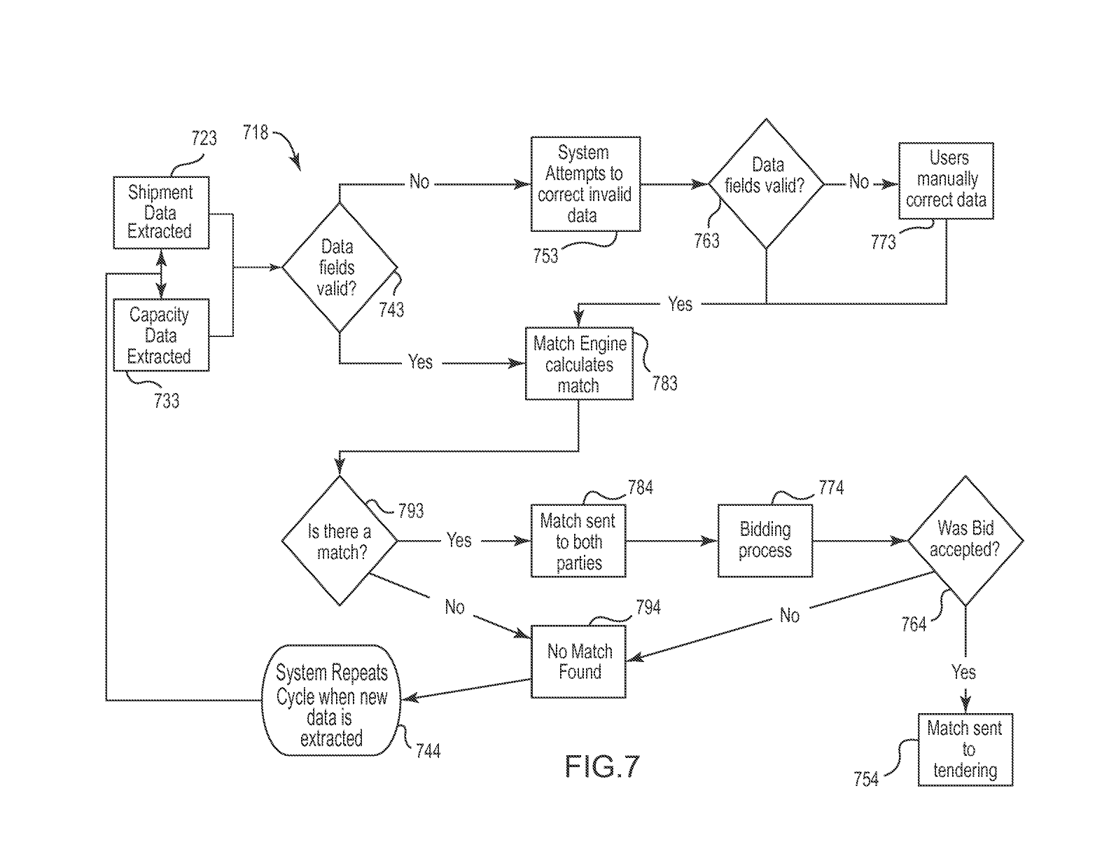

Turning now to FIG. 7, seen is a flowchart representation of a method 718 of matching a matching a load such as, but not limited to the load 112 seen in FIG. 1 with an available capacity such as, but not limited to the capacity 114 seen in FIG. 1. In one method 718, a newly obtained load 112, which may also be referred to herein as a shipment or any other similar term known in the art, may be posted and sent to the web server 101 for matching with carrier capacity 112 that is available (and which may also be obtained by posting at the web server through automatic or manual posting. The load 112 may comprise data 116 that is extracted 723 from the shipper/broker system 103. Capacity data 114 may also be extracted 733 from the carrier system 104. It is contemplated that capacity 114 may also be extracted from the shipper/broker system 103 (e.g., when the shipper/broker system 103 comprises a broker system). At 743 the method 718 determines whether the load 112 and capacity data 114 is valid. If the data is valid, the data is then sent to the match engine. One match engine may comprise a portion of the web server 101, database server 102, or any other part of the system 100. Alternatively, the match engine may reside on a separate device such as, but not limited to a matching server (not shown) which may be communicatively coupled to the web server 101 or any other portion of the system 100. In the case when one or more fields of the data are found to be invalid or missing at step 743, at step 753, the system 100 may correct or augment the invalid data. Data may be augmented or corrected by comparing existing data to expected data and making changes as determined by the matching system software. At step 763, the stem 100 checks again as to whether the data fields are valid. If not, then at 773, the system 100 may notify the shipper 108 or carrier 106 of invalid data fields. Upon receiving such notification, the shipper 108 or carrier 106 may manually correct the invalid data 306.

If, at steps 743 and 763, the data fields are found to be valid, the final load and capacity data is sent to the match engine. At 783, the match engine may calculate and score or rank potential matches between the load(s) and capacity(s). For example, the match engine may score each attribute and rank the results. In one example, a truck may be located ten miles from the pickup location (which may receive a high ranking/score), but may also be located 300 miles from the drop off location (which may receive a low ranking/score), which may be compared to a truck 300 miles from the pickup location and ten miles from the drop off location. The matching engine will score and rank those two options and present the highest scored options first. At 793, the match engine may then determine whether there is a match. For example, upon the match engine scoring each attribute and then ranking the results, you may have a truck 10 miles from the pickup (high score) but 300 from the drop off (low score) compared to a truck 300 miles from the pickup and 10 miles from the drop off. The matching engine will score and rank those two options and present the highest scored options first. In the case where no match is possible for the provided load 112 and capacity 114, the match may be identified as no match found at 794. With enough posted loads and capacity, every load and capacity should eventually find a match. However, if a load needs to be delivered within a certain timeframe (e.g. the next 24 hours) and all the trucks are busy for that timeframe, the load may not be delivered. In the case where there is a successful match between load 112 and capacity 114, at 784 the match may be sent to the parties (e.g., shipper and carrier) with one or more notifications 111. The parties may then begin a bidding process at 774 as seen by the negotiations 116 in FIG. 1. In the case where an offer/bid is not accepted by the shipper or a counteroffer/bid is not accepted by the carrier at 764 and negotiations are complete, the match is deemed no match found 794. It is contemplated that a failure to respond to an offer may occur (ignoring the offer). For example, a carrier may be given an offer that is too low or doesn't meet certain conditions so they may reject the offer. Another possible scenario is that nobody responds to an offer which, in effect, may expire the offer. One system 100 may comprise a “failsafe” feature that expires all deals, loads and capacity (trucks) after a specified time period of, for example, five days, which may clean up all remaining data received and obtained from TMS systems which fail to clean up their own data. When a match is deemed no match found at 794, the system may repeat itself when new data is automatically extracted from the shipper/broker system 103 and/or the carrier system 104 or manually entered into the system 100. In the case where a bid is accepted at 764 and negotiations are complete, the match is sent to be tendered at 754.

One embodiment of the system 100 may comprise a Harmonized Commodity Description and Coding System (HS). An HS system tariff nomenclature is an internationally standardized system of names and numbers for classifying traded products developed and maintained by the World Customs Organization (WCO) (formerly the Customs Co-operation Council), an independent intergovernmental organization with over 170 member countries based in Brussels, Belgium. One HS term may comprise an HS category code term which may identify one or more types of goods.

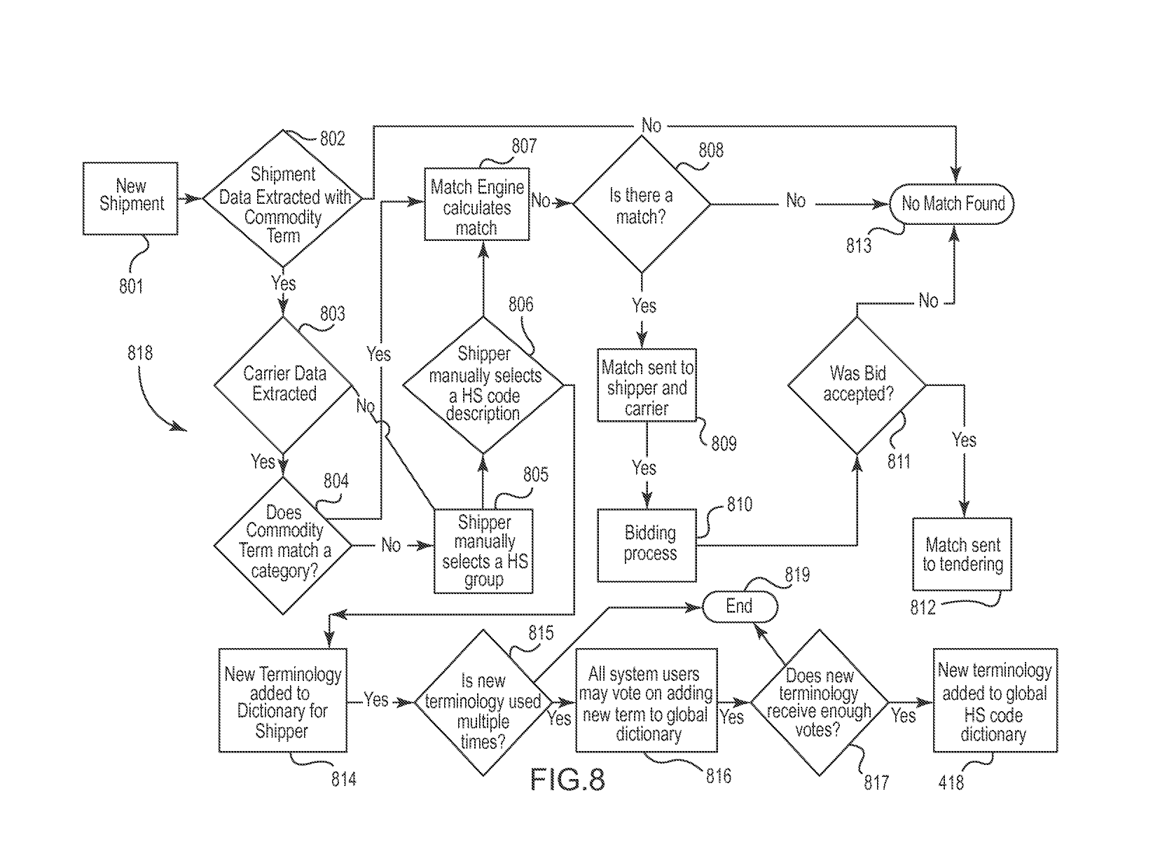

Turning now to FIG. 8, seen is a flow chart of one method 818 of matching loads and capacity. The FIG. 8 method 818 may comprise a matching method based on HS codes. One method 818 may start at 801 when a new shipment is requested by a shipper. For example, a shipper 108 seen in FIG. 1 may request a shipment and the shipper/broker system 103 may post a load 112 to the web server 112, where the load 112 comprises details about the shipment. Such details may comprise a commodity term which identifies the type of goods being shipped by the shipper 108. At 802, it is determined whether a commodity term may be extracted from the shipper/broker system 103 or from the information posted to the web server 104, database 102, or any other system 100 device. If not, then the match for the load 112 is marked as no match found at 813. If a commodity term is obtained from the load 112, then at 803, it is determined whether an HS code category may be extracted from the capacity 114 post or through extracting the capacity 114 data from the carrier system 104. If an HS code category is found in the capacity 114, then at 804 it is determined whether the commodity term from the load 112 matches with the HS code category from the capacity 114. If the commodity term from the load 112 is a match with the HS code category from the capacity 114, the load 112 and capacity 114 are sent to the match engine and at 807 a match for the load 112 and capacity is determined. If the commodity term and HS category do not match at 804 or if no HS code is found in the Carrier data at 803, then the shipper 108 may be prompted to manually select an HS group at 805 and an HS code description at 806 from the user interface prompt. The data may then be sent to the match engine to calculate a match at 407.

If, at 808, the match engine determines that there is no match, then the match is identified as no match found 813. For example, either no load or truck matches in any form or shape OR the quality if the match is too low to display to the user. The match engine may use a scoring method based in part on commodity terms to find potential matches between parties. One embodiment may comprise a scoring engine to implement the scoring method. One scoring engine may comprise at least a portion of one or more devices seen in FIG. 1 or any other figure. The scoring engine may provide a score for one or more features of each load/carrier match such as, but not limited to, distance, timing, and whether there are any inter-party business relationships related to the load, carrier, or both. For example, each user (carrier, shipper, etc.) of the system 100 may comprise a user configuration where the user may identify various matching rules to apply to the user or a particular feature of the shipment/load such as, but not limited to, a shipment/load type of pickup or destination location, etc. These rules and configurations may determine the search constraints in one embodiment. Each scoring feature may be assigned a different weight to reflect its relevance for determining the strength of the match. A match with a higher score may comprise a more favorable match to at least one of the shipper, carrier, and/or broker as compared to a match comprising a lower score. Therefore, a shipper, broker, and/or carrier may select the higher-scored match to begin negotiations within. However, it is also contemplated that a load, truck, or any other feature in the system 100 may be involved in a plurality of simultaneous negotiations. Upon selection of an offer or counteroffer in one of the simultaneous negotiations, any such load, truck, or other feature will be removed from or other prevented from being reserved in all other simultaneous negotiations. Turning now to 808, the engine may determine that there is a match between load 112 and capacity 114, then at 809, and as seen in FIG. 1, a match notification 117 is sent to the shipper 108 and/or broker 107 and the carrier 106 who then may commence the bidding process at 810. The term match notification 117 may be referred to here as a match. If, at 811, a bid/offer/counteroffer is accepted during negotiations 111, the match notification 114 may be sent to a tendering server. The tendering server may comprise a portion of the web server 101, database server 102, carrier system 104, shipper/broker system 103, may comprise any other portion of the system 100 seen in FIG. 1 or may comprise a new device not shown in FIG. 1. If the bid is not accepted at 811, the match notification 114 comprises a no match found match notification 114 at 813.

At 805 and 806, if a shipper 108 or broker 107 manually selects an HS group and enters an HS code description, respective, then at 806, the newly entered HS code description will be automatically entered into an HS code description database for the shipper 108, broker 107 and/or carrier 106 at 814. The HS code description may be referred to herein as a dictionary or personal dictionary. At 815, it is determined whether this is the first time the manually entered description is used or if the new term has now been used for additional loads 114 (i.e., term is used multiple times). If so, then at 816 all users of the system may vote on adding the new description/term to a global dictionary database for all users. The global dictionary database may be accessed by, and reside on, any of the devices in the system 100 or may comprise a separate device. A commodity date may be normalized. For example, a TMS may state that the shipper of carrier may not accept “chickens,” but an international official list may only refer to “fowl” or “pets.” In one embodiment, such an official list may be modified with individual TMS terms. Over time, the community may correct or otherwise adjust the list to be more effective in overcoming the issue of nobody using specific terms. If, at 817, the new term receives a predetermined number of votes, the new term is then added to the global HS code dictionary at 818. If, at 815 or at 817 the method 818 determines that the new description has not been used previously or has not received enough votes, respectively, then the method ends 818 until a new shipment 801 is received, at which point the method 818 may run again.

Operators of commercial motor vehicles (“CMV's”) are frequently required to comply with performance standards and regulations for operating such vehicles. For example, some operators of CMV's are required to meet hours-of-service regulations.

In the U.S. Department of Transportation, the Federal Motor Carrier Safety Administration has established a comprehensive list of regulations that professional operators of CMV's must often comply with. These regulations govern drivers, CMVs, trucking companies (sometimes called “carriers”) and/or the CMV's belonging to the carriers. Operators must often comply with obligations imposed under federal and state requirements. Such regulations not only include physical and age requirements, but may also provide how an operator may lose a commercial driving privilege.

According to the US Department of Transportation, motor carrier drivers must use an electronic on-board recording (EOBR) device shall use such device to record the driver's hours of service. Automatic on-board recording devices shall produce, upon demand, a driver's hours of service chart, electronic display, or printout showing the time and sequence of duty status changes, including the drivers' starting time at the beginning of each day.

The device enables authorized Federal, State, or local officials can immediately check the status of a driver's hours of service. This information may be used in conjunction with handwritten or printed records of duty status, for the previous 7 days.

EOBRs installed in commercial motor vehicles can monitor and record a whole host of data about the vehicle and its driver. From electronic driver logs that track a driver's Hours of Service and electronic driver vehicle inspection reports to driver behavior reporting on speeding, idling and hard braking Many EOBRs integrate map and route solutions as well, which can help drivers navigate around construction and avoid high-traffic areas.

EOBRs may connect directly to a vehicle's engine control module and store data, as well as transmit it wirelessly to the motor carrier (not the DOT). There, analytics reports can help drivers and fleets manage performance more effectively to cut fuel costs, ensure timely vehicle maintenance, identify drivers for additional training before accidents occur and help provide real-time data to shippers for better customer service.

Many CMV's are equipped with electronic-on-board-recorders to record information relating to the CMV's. The information generally includes names of the carriers, and the U.S. Department of Transportation number of the CMV's. For compliance purposes, operators of the CMV's are also frequently required to collect other relevant information of the drivers such as name, duty status, date and time, locations of the CMV's, and distance traveled. As part of the standards and/or regulations, the operators are required to submit the collected information. Operators frequently submit the collected information on paper. Paper-based processes are often slow. As a result, important compliance information might not be received in time to enforce certain regulatory requirements or to take other relevant actions based on the information.

An Electronic On-Board Recorder (EOBR) may be referred to herein as an electronic device attached to a commercial motor vehicle, which is used to record the amount of time a vehicle is being driven. Data that may be captured comprises (a) duty status; (b) date and time; (c) location of the commercial motor vehicle (CMV); (d) distance traveled; (e) name and USDOT Number of the motor carrier; (f) 24-hour period starting time (e.g., midnight, 9 a.m., noon, 3 p.m.); (g) a multiday basis (7 or 8 days) used by the motor carrier to compute cumulative duty hours and driving time; (h) hours in each duty status for the 24-hour period; (i) total hours; (j) truck or tractor and trailer number; (k) shipping document number(s), and/or name of shipper and commodity; (l) engine telemetry, which may comprise data related to maintenance or vehicle performance such as, but not limited to, tire pressure, fuel level, oil level, brake condition; (m) mobile communications systems, which may connect all EOBRs to a central system and facilitate communications between any vehicle device and a central dispatch.

One embodiment of the invention described herein may be adapted to interface and transmit—upload/download data from electronic on-board recording devices (EOBR) operating in commercial motor vehicles. For example, one embodiment may comprise extracting data from an electronic on-board recording device (EOBR) where the data is used to determine if (a) a carrier has enough available hours of service (HOS) to accept a freight shipment and (b) the carrier (e.g., driver) will be able to reach the destination of delivery requested based on the EOBR data, HOS data, calculated miles per hour and distance of travel. Data may be extracted directly from the EOBR via any available means of the EOBR device, including Wi-Fi, Cellular, and Satellite communications technology. The extracted data may also be used to block a carrier from a match to a freight shipment if the HOS data or other data is determined unacceptable to the match requirement. It is also contemplated that the EOBR and HOS data may be extracted from one or more of the following sources: third party transportation systems and directly from the EOBR mobile communications software. It is also contemplated that satellite data transfer may also be used for other any information described herein, in addition to, or besides EOBR data. Such satellite and/or other mobile communication data may comprise live data (e.g., streaming).

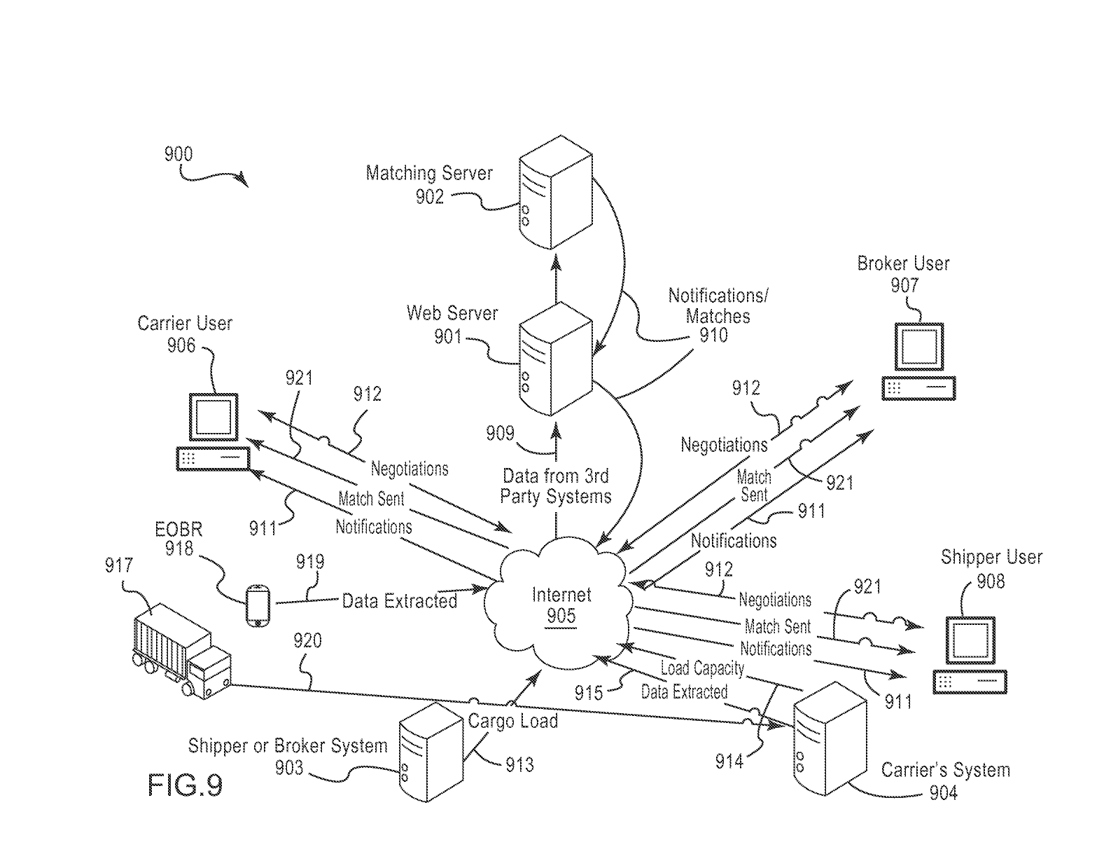

FIG. 9 comprises an overview of an exemplary embodiment of the system 100 seen in FIG. 1, but also including an EOBR device 918 and CMV 917. Similar to the FIG. 1 system 100, the FIG. 9 system 900 automatically matches cargo loads 913 provided from a shipper/broker system 903 with available capacity 914, also referred to herein as load capacity or capacity. In general, the term “carrier” is used herein to refer to a trucking company, and the term “shipper” is used herein to refer to a company that engages a carrier to transport a load of freight. The term “broker” is used herein to refer to an entity that may represent and act on behalf of a carrier or a shipper. The phrase “Third Party Logistics” or “3PL” or “TPL” is often used in the freight industry in the place of “broker.”

One system 900 may comprise a web server 901 in communication with a matching engine server 902. The matching engine server may also be referred to herein as a database server. The web server 901 may be in further communication with the Internet 905 to permit carriers 906, brokers 907, and shippers 908 to access resources residing therein through the use of a web portal and web browser, for example. The web server 901 may comprise data and content organized on one or more web pages associated with one or more websites that are accessible and viewable by the carriers 906, brokers 907, and shippers 908 using a web browser program executing on a computing device such as a personal computer or laptop. The carriers 906, brokers 907, and shippers 908 may also submit information and data to the web server 901 and the database server 902 using the web browser and other programs.

One match engine server 902 may be coupled to the web server 901 via a computer network (local area network, metropolitan area network, wide area network, virtual private network, intranet, Internet, etc.). The match engine server 902 may be operable to store data, and operate the system algorithm to match shipments with carrier capacity based on data fields relating to freight. In particular, the match engine server 902 may be operable to store load data and operate a software matching algorithm on data including but not limited to load size, commodity type, load preferences, trailer type preferences, pickup and delivery location preferences, and other accessorial information such as, but not limited to, straps, tarps, chains, nail downs, or anything else that is “extra” but potentially required to move the load.

It should be understood that the system 900 may employ a single powerful server to perform the functions of both the web server 901 and match engine server 902. Alternatively, multiple devices may be employed to provide the web server functionality and/or the match engine server functionality. The web server 901 and match engine server 902 may reside behind a firewall or other forms of security measures. Data backup servers may be used as well as other data storage services such as cloud servers.

One system 900—for example, the web server 901, may automatically query a shipper/broker system 903, which may comprise a TMS system, to extract data of a particular shipment or load 913. Further, the system 900 may automatically query the carrier's freight system 904 to extract capacity data 914. The shipper/broker system 903 and/or the carrier system 904 or any other portion of the system 900 may be accessed and data may be extracted via the internet 905, and via a means of one of file access, socket direct protocol, web services, or EDI and uploaded to the web server 901. The data obtained from the shipper/broker system 903 and carrier system 904 may be combined into a single data structure and referred to herein as third party data 909, which may be uploaded to the web server 901. The match engine server 902 may performs a matching function 910 for the load 913 such that shippers 908 may be presented with carriers 906 and/or brokers 907 having available capacity 914 to ship the load 913. Shippers 908 and/or brokers 907 may then conduct negotiations 912 with carriers 906. One system 900 may provide notifications 911 to all parties during the matching and negotiation processes.

One Commercial Motor Vehicle (CMV) 917 may be equipped with an Electronic On-Board Recorder (EOBR) 918. EOBR data 919 may be extracted from the EOBR and sent either over the internet 905 directly to the web server 901, or sent 920 to a third party freight system such as, but not limited to the carrier system 904. The data 919 may then be forwarded 915 to the web server 101 via the data extraction process.

A graphical user interface may be made available to all users of the system 100, providing the users the capability to view matches 921, negotiate 912 loads and capacity, send and receive notifications 911, and sign contracts.

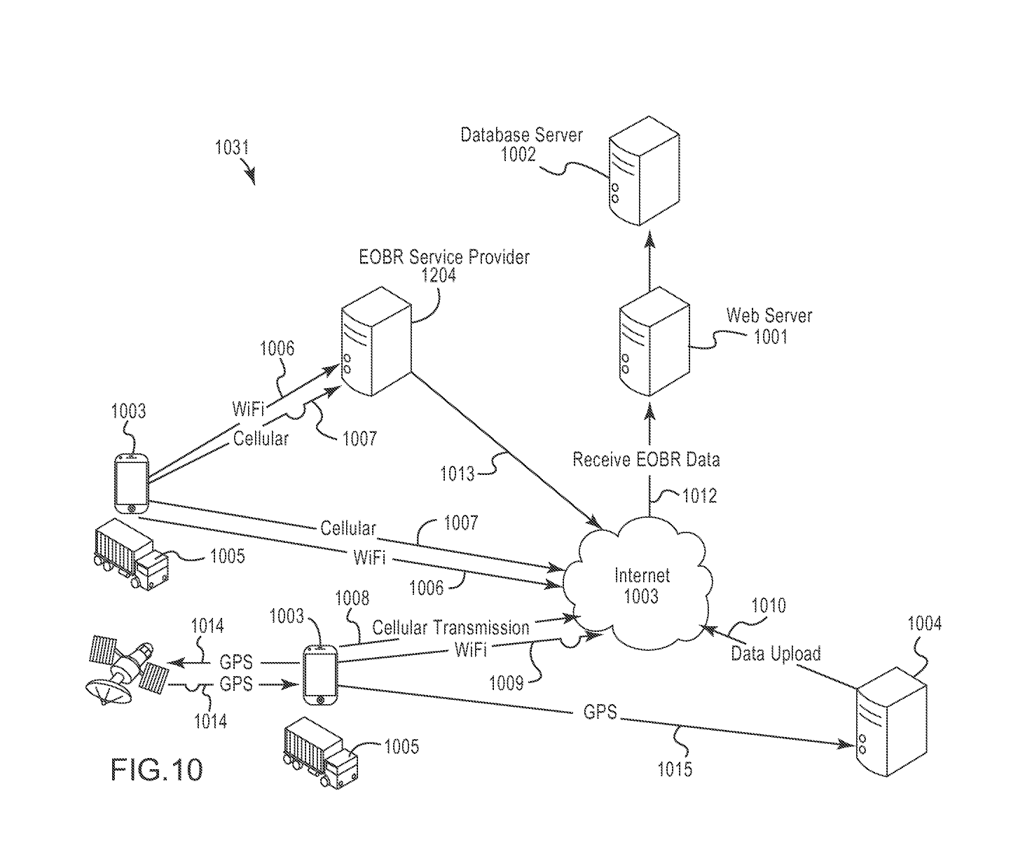

Turning now to FIG. 10, seen is a diagram of the exemplary system 1031 showing an EOBR service provider 1004 extracting data from an EOBR 1003, and further having a web server 1001 extract data from the EOBR service provider 1004. An EOBR service provider 1004 may provide access to the data received form the EOBR 1003 through a mobile communications software such, as, but not limited, a non-transitory, computer-readable storage medium loaded with processor-readable functions comprising a method to perform one or more steps. A CMV 1005 may be equipped with the EOBR 1003. Data from the EOBR 1003 may be extracted and sent via Wi-Fi 206, cellular 207, or any other communications system known in the art, to (a) the EOBR service provider 1004, and/or (b) the web server 1001 via the internet 1003. The EOBR Service Provider 1004 may then send 1013 the EOBR data via the internet to the web server 1001. The web server 1001 may forwards all data to the database server 1002.

EOBR devices 1003 may have an optional GPS or Location Based Services feature to provide mapping and location services to the carrier. In the case where GPS or Location Based Services 1014 are used, the location data may be sent 1015 to the EOBR service provider 1004 for forwarding 1010 to the web server 1001 or alternately sent directly via cellular 1008 or Wi-Fi 1009 connection and the web server 1001 may receive 1012 the EOBR data.

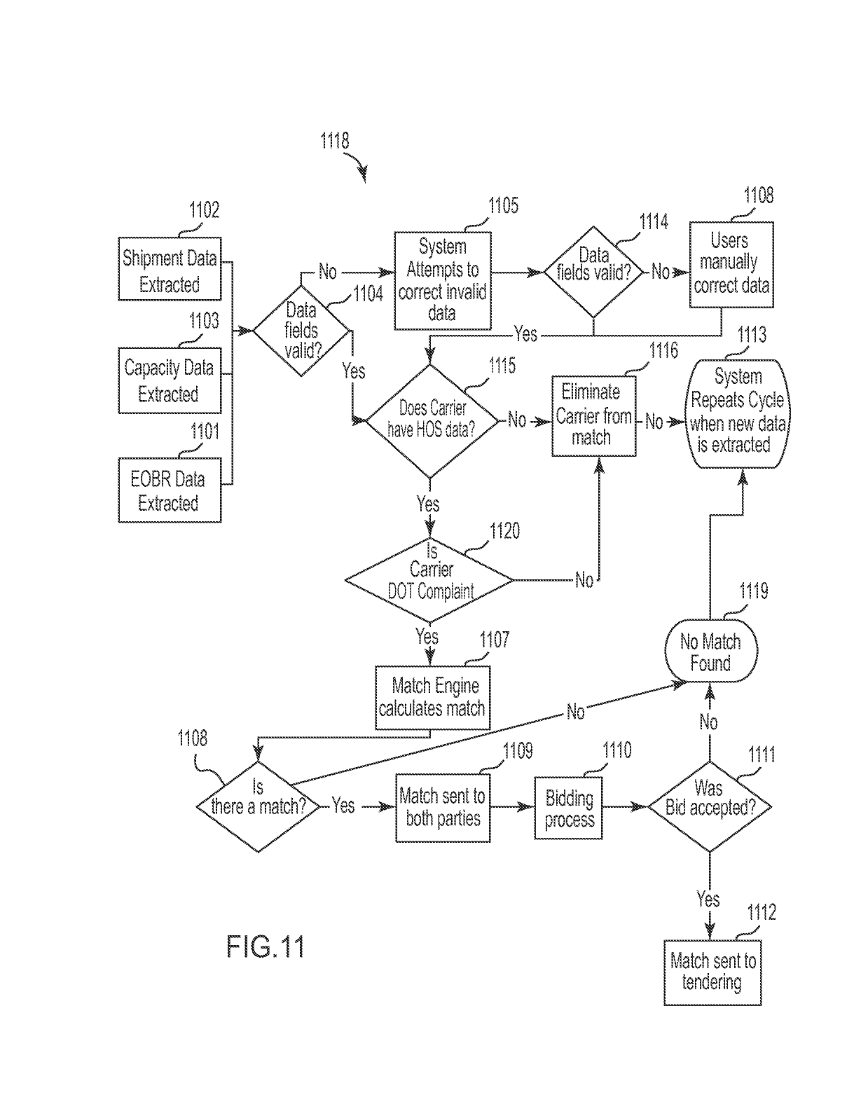

Turning now to FIG. 11, seen is a method 1118 comprising further detail on a matching process using data from the electronic on-board recorder (EOBR) 1003 seen in FIG. 10 and described above. In one method 1118, shipment (load) data extracted from the shipper/broker system 103 or obtained from the shipper 108 at 1102, the load capacity data extracted from the carrier system 103 or obtained from the carrier 106 at 1103, and the EOBR data extracted from the EOBR 1003 at 1101 are analyzed at 1104 to determine if all the data fields in the data are valid. In the case where one or more data fields are found to be invalid, the system attempts to correct the invalid data at 1105. The data is then analyzed to determine validity at 1114. In the case where one or more data fields are still found to be invalid, the shipper 108 or carrier 106 may be provided a notification 111 via a user interface to manually correct the data at 1106.

When the data provided at 1102, 100 and 1101 are each found to be valid at 1104 and 1114, or a user has manually entered the valid data at 1106, the data is analyzed for further validation. The first validation is at 1115 to determine if the carrier has HOS data available. If no HOS data is available, at 1116 the carrier is eliminated from a potential match for the shipment data 1102, and at 1113 the system will repeat the method 1118 when new data is extracted at 1102, 1103 and/or 1104. If there is HOS data available, then at 1120, HOS data is analyzed to determine if the carrier is DOT compliant. DOT compliant may comprise whether the CMV is in compliance with DOT regulations on Hours of Service. If the carrier is DOT compliant, then at 1107 the data may be sent to the match database 102 to calculate a match of a shipper load to carrier load capacity. If the carrier 106 is not DOT compliant, then the carrier 106 may be eliminated from the match process at 1116 and the method 118 may move to 1113. At 1108, the match engine may determine whether there is a match between the carrier and 106 and shipper 108 for the posted load 112 and capacity 114. In the case where no match is possible based on the data, the match designated as no match found at 1119 and the method 1118 moves to 1113. In the case where there is a successful match at 1108, then at 1109 the match is sent to the parties with notifications 111 and at 1110 a bidding process is initiated through ongoing negotiations 112. At 1111, it is determined whether a counteroffer/offer has been accepted. In the case where an offer/counteroffer is not accepted and negotiations are complete, the match is deemed no match found at 1119. This typically occurs when the load or truck is retracted (no longer available) or the system times it out (currently set to 5 days). In the case where a bid is accepted at 1111 and negotiations are complete, the match is sent to be tendered at 1112.

A system and method for offering, negotiating, and confirming freight business between two parties is disclosed. In certain embodiments, a shipper posts a shipping need on the service and is matched with one or more carriers that meet the posted requirements. A bidding system is presented and negotiations are conducted until the shipper accepts a bid. Upon acceptance, legal documents are prepared, digitally signed, confirmed, and payment is processed by the service.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A non-transitory, tangible computer-readable storage medium, encoded with a processor readable instructions configured to perform a method of completing a freight shipment contract for comprising,
interfacing with one or more,
transportation management systems,
mobile communications devices, and
load boards;
transmitting data comprising one or more available freight loads and available freight capacity from the one or more transportation management systems and load boards in substantially real time;
reviewing the one or more available freight loads and freight capacity;
matching one or more of the one or more available freight loads with one or more of the one or more available freight capacity;
negotiating one or more details of a contract between a first entity associated with the one or more of the available freight loads and a second entity associated with one or more of the freight capacity;
confirming the details between the first entity and the second entity;
collecting invoicing information; and
providing electronic receivables.

2. The non-transitory, tangible computer-readable storage medium of claim 1 wherein,
the contract comprises at least one of a,
rate,
commodity,
freight data, and
terms of a transaction; and further comprising,
exchanging between at least two of a broker, shipper and carrier the at least one of a
rate,
commodity,
freight data, and
terms of a transaction;
using electronic signatures by the at least two of the broker, shipper and carrier to legally confirm the at least one of a,
rate,
commodity,
freight data, and
terms of a transaction; and
the mobile communications devices comprises a gps-enabled device.

3. The non-transitory, tangible computer-readable storage medium of claim 1 wherein, transmitting data comprising one or more available freight loads and freight capacity from the one or more transportation management systems in substantially real time comprises utilizing one or more of,
direct database access;
file access;
socket direct protocol;
electronic data interchange and
web services.

4. The non-transitory, tangible computer-readable storage medium of claim 1 wherein, the transportation management systems and load boards comprise third-party transportation management systems and load boards.

5. The non-transitory, tangible computer-readable storage medium of claim 1 wherein the data further comprises one or more of,
origin location;
destination location;
pick up date;
delivery date;
flexibility of pick up date;
flexibility of delivery date;
type of carrier equipment;
commodity;
accessorial information;
licenses required;
licenses desired;
number of hours;
hazardous material information;
insurance information; and
driver compliance information.

6. The non-transitory, tangible computer-readable storage medium of claim 1 further comprising, notifying one of more of a shipper, broker, and carrier of one or more of,
an offer;
an acceptance;
a rejection;
general messages
available matches;
negotiation status updates;
load offers; and
rate confirmations.

7. The non-transitory, tangible computer-readable storage medium of claim 6, wherein,
notification is provided via one or more of,
a mobile communications text,
an e-mail communication,
a mobile-application communication comprising at least one of,
a push communication, and
a non-push communication, and
an interactive pop-up alert window;
the window displays,
status information,
an icon to differentiate between status types; and wherein,
the window further allows for actions to be taken to proceed to a next step in a match, negotiation, offer, or confirmation process.

8. The non-transitory, tangible computer-readable storage medium of claim 1 wherein,
matching one or more of the one or more available freight loads with one or more of the one or more available freight capacity comprises utilizing information received from one or more of,
a shipper;
a broker;
a carrier;
the one or more transportation management systems system;
load boards;
a system adapted to make at least one of freight loads and freight capacity accessible via a network;
information input manually in a spreadsheet or a spreadsheet-compatible data file; and further comprising,
presenting to one or more carriers via a user interface information related to the shipper.

9. The non-transitory, tangible computer-readable storage medium of claim 1 further comprising: making at least one of a bid and an offer to a shipper to complete a desired shipment.

10. The non-transitory, tangible computer-readable storage medium of claim 1 further comprising,
viewing bids by one or more carriers; and
at least one of,
accepting the bid,
declining the bid, and
countering the bid.

11. The non-transitory, tangible computer-readable storage medium of claim 1 wherein, negotiating one or more details of a contract between the one or more of the available freight loads and one or more of the freight capacity comprises anonymously negotiating.

12. The non-transitory, tangible computer-readable storage medium of claim 1, further comprising: agreeing to terms of the contract by a shipper accepting a bid after negotiating one or more details of the contract; and wherein, one or more of the shipper and a carrier are not anonymous.

13. The non-transitory, tangible computer-readable storage medium of claim 1 further comprising: exchanging between one or more of a shipper, broker and carrier one or more of a,
rate;
commodity;
freight data; and
terms of a transaction.

14. The non-transitory, tangible computer-readable storage medium of claim 1 further comprising:
preparing contract documents, wherein the contract documents comprise a rate confirmation;
electronically sending the contract documents to one or more of a shipper, broker and carrier; and
creating a legally binding agreement through the exchange of one or more electronic signatures of the contract documents

15. The non-transitory, tangible computer-readable storage medium of claim 1 further comprising: sending confirmations to one or more of a shipper, broker and carrier.

16. The non-transitory, tangible computer-readable storage medium of claim 1 further comprising:
automatically transmitting one or more details of an agreed-upon load to a transportation management system; and
automatically creating a load in the transportation management system.

17. The non-transitory, tangible computer-readable storage medium of claim 16 wherein, the transportation management system comprises one of,
a carrier system;
a shipper system; and
a broker system.

18. The non-transitory, tangible computer-readable storage medium of claim 1 further comprising:
collecting the load details from a carrier's transportation management system upon a freight invoice being created, wherein the details comprise one or more of,
a rate,
a charge,
accessorial information, and
tax information;
transmitting the load details to a carrier; and
initiating payment from the one of a shipper and broker.

19. The non-transitory, tangible computer-readable storage medium of claim 1 further comprising:
receiving freight invoice information from a carrier; and
at least one of,
providing the freight invoice information to at least one of a shipper transportation management system or broker transportation management system, and
transmitting the freight invoice information to at least one of a shipper and a broker through at least one of,
direct database access,
file access,
socket direct protocol,
electronic data interchange, and
web service; and
registering the freight invoice for payment within at least one of a shipper or a broker accounting system.

20. The non-transitory, tangible computer-readable storage medium of claim 1 further comprising:
collecting remittance details from a shipper; and
sending the remittance details, an acceptance, a receipt, and a payment to a carrier.

21. A method of completing a freight shipment contract comprising,
interfacing with one or more,
transportation management systems, and
load boards;
transmitting data comprising one or more available freight loads and available freight capacity from the one or more transportation management systems and load boards in substantially real time;
reviewing the one or more available freight loads and freight capacity;
matching one or more of the one or more available freight loads with one or more of the one or more available freight capacity;
negotiating one or more details of a contract between a first entity associated with the one or more of the available freight loads and a second entity associated with one or more of the freight capacity;
confirming the details between the first entity and the second entity;
collecting invoicing information; and
providing electronic receivables.

22. A freight shipment booking system adapted to,
interface with one or more,
transportation management systems, and
load boards;
transmit data comprising one or more available freight loads and available freight capacity from the one or more transportation management systems and load boards in substantially real time;
review the one or more available freight loads and freight capacity;
match one or more of the one or more available freight loads with one or more of the one or more available freight capacity;
negotiate one or more details of a contract between a first entity associated with the one or more of the available freight loads and a second entity associated with one or more of the freight capacity;
confirm the details between the first entity and second entity;
collect invoicing information;
provide electronic receivables;
enable at least one of a driver and the freight carrier to opt into a track and trace service, and
have a location used for the matching the available freight loads with the available freight capacity.

23. The system as described in claim 22 further comprising: an applet or application operating on a portable computing device comprising the capability for the carrier to opt into a track and trace service wherein the carrier is tracked via GPS or mobile phone tracking, and further said tracking information is made available to the broker or shipper whose load is being transported by the carrier.

24. The track and trace service as described in claim 22 further comprising: wherein the application user optionally may select data obfuscation so that the GPS or mobile phone tracking information of the carrier is provided as a general location for presentation purposes.

25. A non-transitory, tangible computer-readable storage medium, encoded with processor readable instructions to perform a method of establishing a freight shipment transaction, the method comprising,
interfacing to one or more,
third party systems,
TMS systems,
load boards,
freight load systems, and
freight capacity systems;
transmitting data comprising one or more data fields at least one of to and from at least one of the one or more third party TMS systems, load boards, freight load systems and freight capacity systems;
identifying a shipping load provided from at least one of a shipper and broker;
searching for a freight carrier with capacity for the shipping load;
matching the at least one of a shipper and broker with the freight carrier;
making at least one of a bid and an offer on the shipping load;
negotiating the freight shipment transaction; and
confirming the freight shipment transaction.

26. The non-transitory, tangible computer-readable storage medium of claim 25, wherein,
identifying a shipping load and searching for a freight carrier with capacity for the shipping load comprises a matching process; and further comprising:
one of correcting and augmenting at least one of missing and inaccurate data when at least one of missing data is detected and inaccurate data is found during the matching process; and
continuing with the matching process.

27. The non-transitory, tangible computer-readable storage medium of claim 24, the method further comprising:
receiving data extracted from,
the one or more,
third party systems,
TMS systems,
load boards,
freight load systems, and
freight capacity systems, and
one or more systems comprising at least one available freight load and freight capacity, and
data received from a shipper;
organizing the data into a format for use in the matching process; and
presenting the data in a user interface of one or more parties in the matching process.

28. The non-transitory, tangible computer-readable storage medium of claim 24, wherein, the load boards comprise one or more third-party load boards; and further comprising,
blocking at least one of the one or more data fields comprising one or more loads from the matching process prior to transmitting the data.

29. The non-transitory, tangible computer-readable storage medium of claim 24, wherein,
at least one of the one or more data fields comprises one or more preference settings;
at least one of the one or more preference settings comprise a value; and
at least one of a shipper and a carrier comprises an interface adapted to modify at least one of the one or more preference settings.

30. The non-transitory, tangible computer-readable storage medium of claim 29, the method further comprising:
using the preference setting to determine a value for each shipper and freight carrier match; and
presenting each shipper and freight carrier match in an order determined by the value.

31. The non-transitory, tangible computer-readable storage medium of claim 24, the method further comprising: modifying at least one of missing, incomplete, and inaccurate data by comparing existing data to expected data.

32. The non-transitory, tangible computer-readable storage medium of claim 24, the method further comprising: eliminating data incompatible with one or more system features.
